(19) United States
(12) Patent Application Publication
(10) Pub. No.: US 2006/0256572 A1
(43) Pub. Date: Nov. 16, 2006

(54) Taillight socket structure

(76) Inventor: Yu-Chu Lin, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/127,122

(22) Filed: May 12, 2005

(51) Int. Cl. B60Q 1/26

(52) U.S. Cl. 362/542

(57) ABSTRACT

A taillight socket structure includes a taillight body having a brake light section. The brake light section comprises a plurality of conical bulb sockets. Each conical bulb socket is mounted with a light emitting diode. Each conical bulb socket comprises an inner wall formed with multiple non-flat refractors and a plurality of indentations around its peripheral portion. The light from the light emitting diodes will be refracted by the refractors of each conical bulb socket to provide a refraction effect, and the light through the indentations of each conical bulb socket will be reflected by the inner wall of the brake light section to enhance the brightness of the brake light section.

### BACKGROUND OF THE INVENTION

1. Field of the Invention

The present invention relates to a taillight socket structure, more particularly to a brake light section provided with conical bulb sockets. Each conical bulb socket comprises an inner wall formed with non-flat refractors and a plurality of indentations around its peripheral portion to enhance the brightness of the brake light section.

2. Description of the Related Prior Art

Conventional taillights on the market can be classified two categories. One is to partition a taillight A into several sections A1, as shown in FIG. 8. Each section A1 has an arc surface A11 with a bulb hole A12 near the center bottom. The arc surface A11 is processed with mirror treatment. When bulbs A2 are activated to light, the arc mirror-treated surface A11 of each section A1 will provide a brighter effect. However, the lifespan of the light bulb is short. If the light bulb is switched with a halogen bulb, the cost is too high.

Another conventional taillight B, as shown in FIG. 9, is partitioned into several sections B1. A brake light section B2 has a number of conical bulb sockets B3. Each conical bulb socket B3 has a bulb hole B31 at the center bottom to be mounted with a light emitting diode B4. Each conical bulb socket B3 comprises a mirror-treated inner wall B32. The brake light section B2 also has a mirror-treated inner wall B21. When the light emitting diodes B4 are activated, the inner wall B32 of each conical socket B3 and the inner wall B21 of the brake light section B2 will enhance the brightness from the light emitting diodes B4. This design uses light emitting diodes B4 to replace traditional light bulbs along with a number of conical bulb sockets B3 to brighten the brake light section B2 for a better warning system to vehicles following it. However, it still has a number of shortcomings. The inner wall B32 of each conical bulb socket B3 is a smooth surface, which provides reflection to only a limited effect.

### SUMMARY OF THE INVENTION

It is the primary object of the present invention to provide a taillight socket structure, which provides a brighter light to warn the vehicle follower.

It is another object of the present invention to provide a taillight socket structure, which provides a safe driving.

It is a further object of the present invention to provide a taillight socket structure, which increases the lighting effect.

### BRIEF DESCRIPTION OF THE DRAWINGS

FIG. 1 is a perspective view of a first embodiment of the present invention, partially sectioned;

FIG. 2 is a perspective view of a conical bulb socket of the first embodiment of the present invention;

FIG. 3 is a perspective view of a second embodiment of the present invention;

FIG. 4 is a perspective view of a third embodiment of the present invention;

FIG. 5 is a perspective view of a fourth embodiment of the present invention;

FIG. 6 is a perspective view of a fifth embodiment of the present invention;

FIG. 7 is a perspective view of a sixth embodiment of the present invention;

FIG. 8 is a front view of a prior art; and

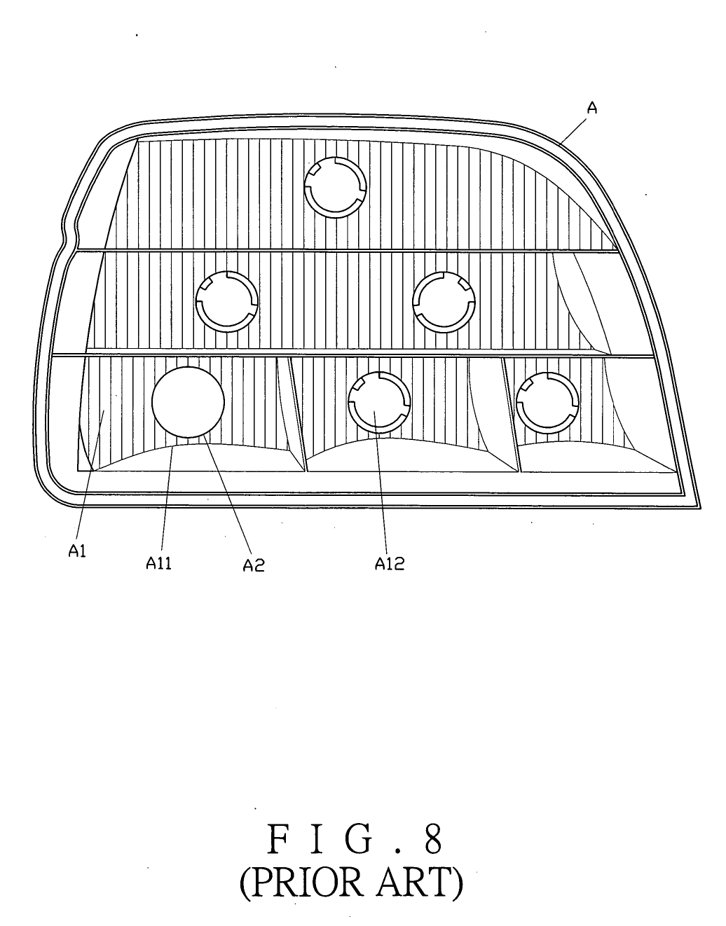

FIG. 9 is a perspective view of another prior art, partially sectioned.

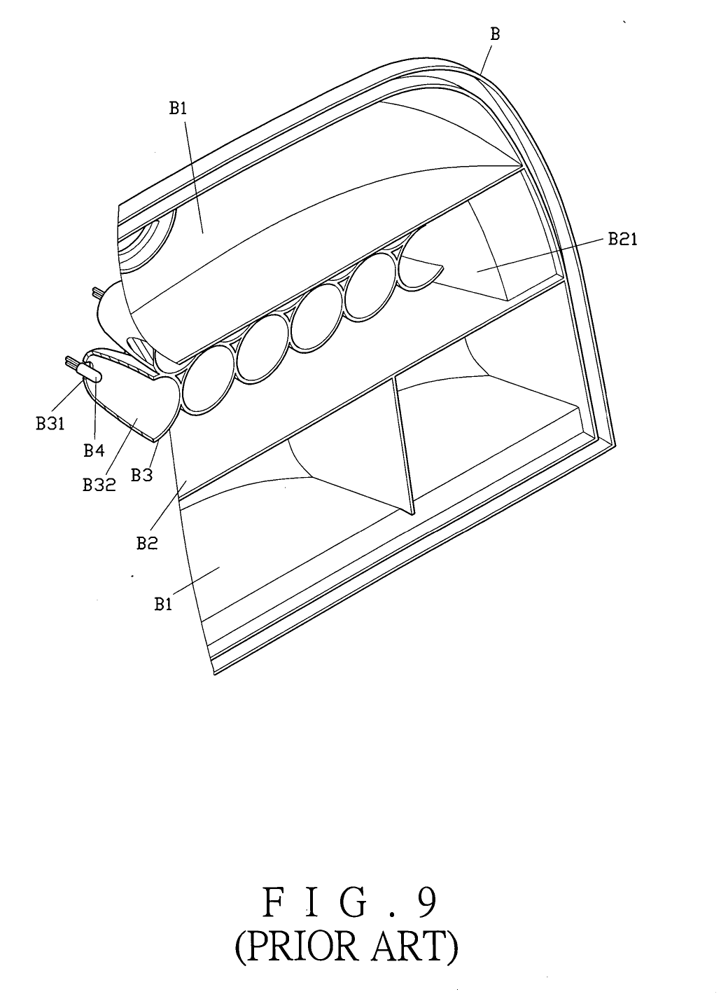

### DETAILED DESCRIPTION OF THE PREFERRED EMBODIMENTS

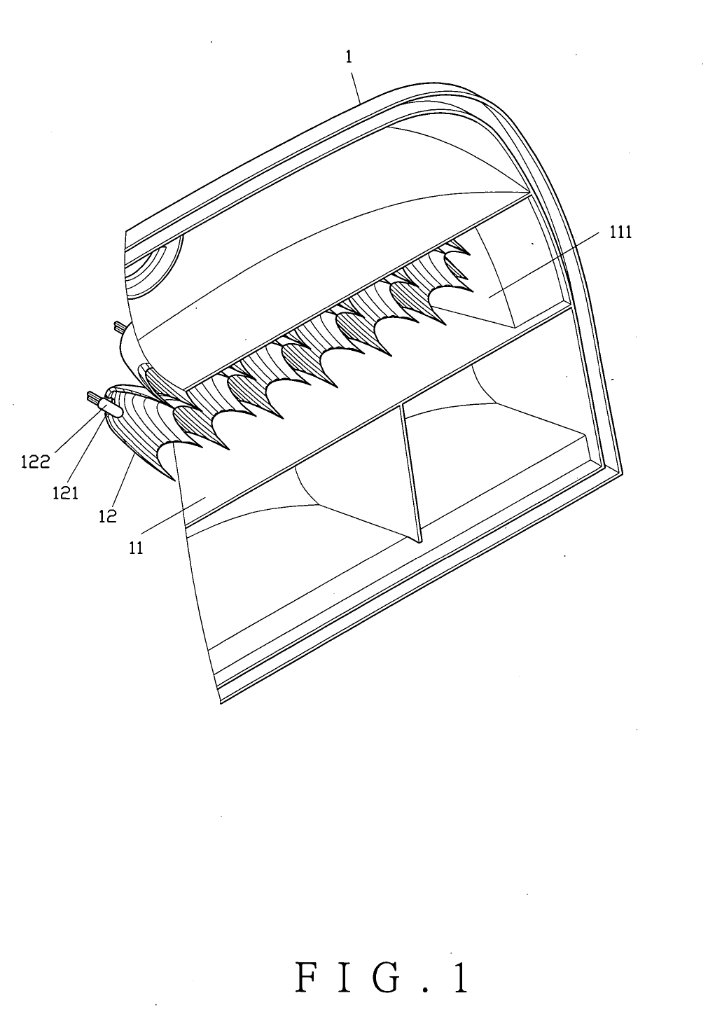

As shown in FIG. 1, the present invention comprises a taillight body 1 having a brake light section 11 therein. The brake light section 11 comprises a mirror-treated inner wall 111 and a plurality of conical bulb sockets 12. Each conical bulb socket 12 has a bulb hole 121 at the center bottom thereof to accommodate a light emitting diode 122 thereon.

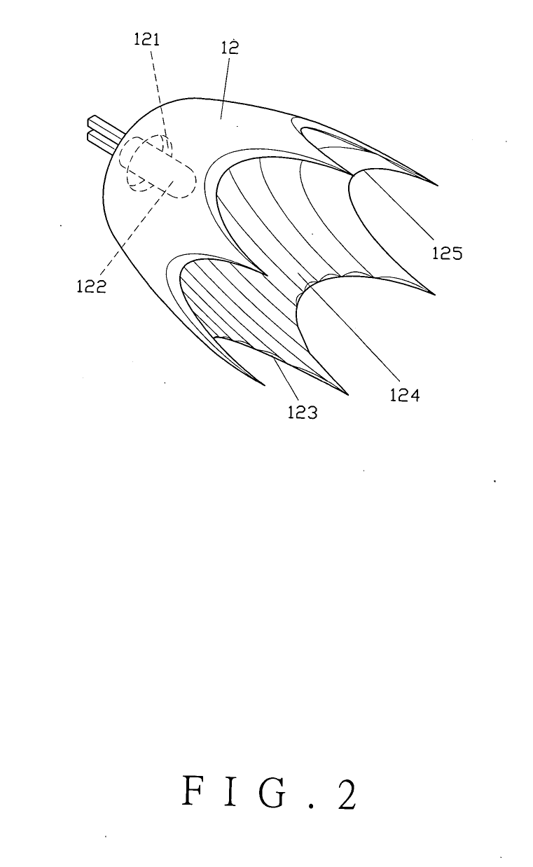

As shown in FIGS. 1 and 2, each conical bulb socket 12 has an inner wall 123 formed with multiple non-flat refractors 124. The refractors 124 are shaped in a strip protuberance. Each conical bulb socket 12 further comprises a plurality of arc indentations 125 around its peripheral portion. The light from the light emitting diodes 122 will be refracted by the refractors 124 on the inner wall 123 of each conical bulb socket 12 to provide a refraction effect, and the light through the indentations 125 of each conical bulb socket 12 will be reflected by the inner wall 111 of the brake light section 11 to enhance the brightness of the brake light section 11.

To further increase the lightness from the brake light section 11, the non-flat refractors 124 on the inner wall 123 of each conical bulb socket 12 can be presented in different shapes.

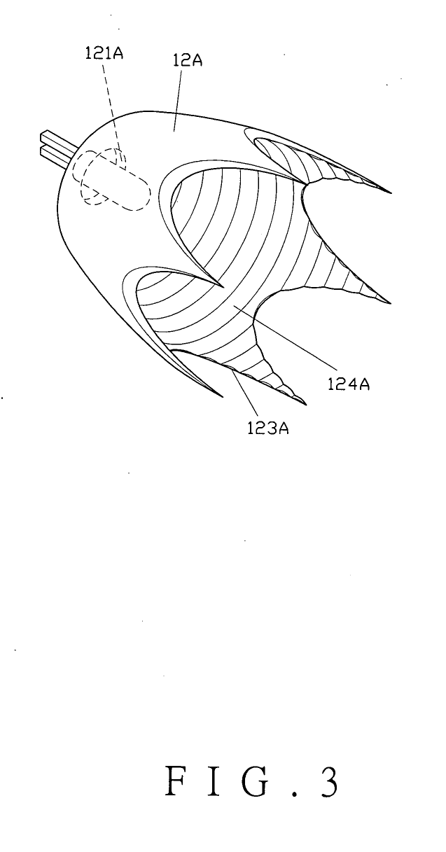

As shown in FIG. 3, a second embodiment of the present invention comprises a conical bulb socket 12A having a plurality of circular refractors 124A. The circular refractors 124A are formed along an inner wall 123A from a bulb hole 121A of the conical bulb socket 12A.

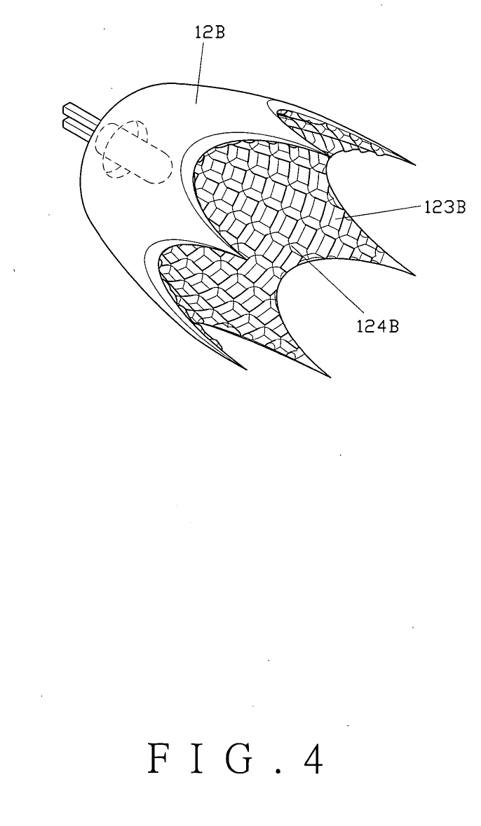

As shown in FIG. 4, a third embodiment of the present invention comprises a conical bulb socket 12B having a plurality of non-flat refractors 124B. The refractors 124B are formed along an inner wall 123B of the conical bulb socket 12B to be arranged in a crisscross pattern.

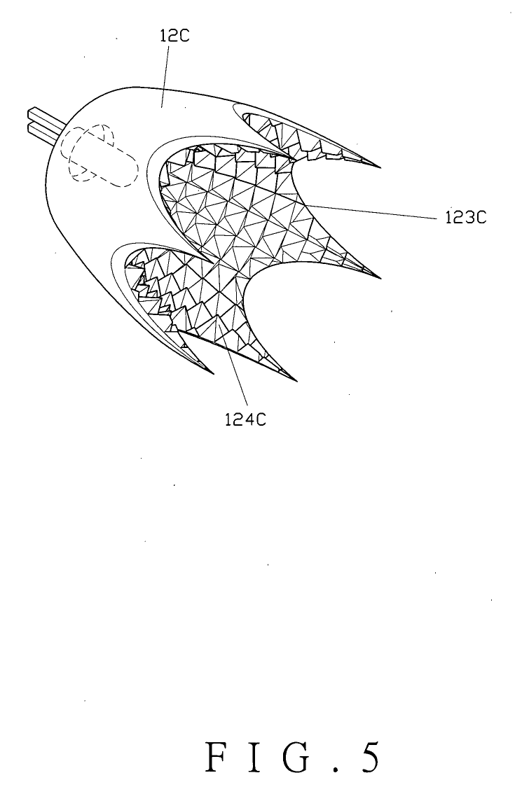

As shown in FIG. 5, a fourth embodiment of the present invention comprises a conical bulb socket 12C having a plurality of non-flat refractors 124C. The refractors 124 C are formed in an awl shape protruded from an inner wall 123C of the conical bulb socket 12C.

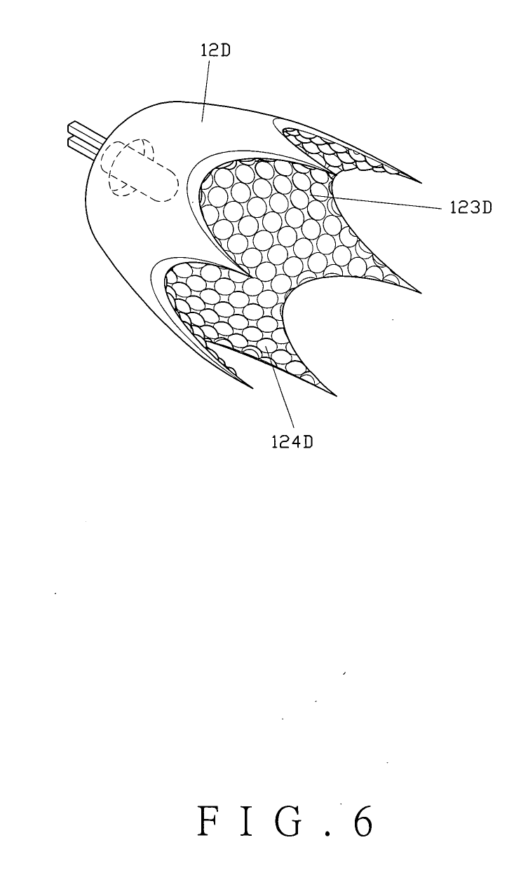

As shown in FIG. 6, a fifth embodiment of the present invention comprises a conical bulb socket 12D having a plurality of non-flat refractors 124D. The refractors 124D are formed in a semi-spherical shape protruded from an inner wall 123D of the conical bulb socket 12D.

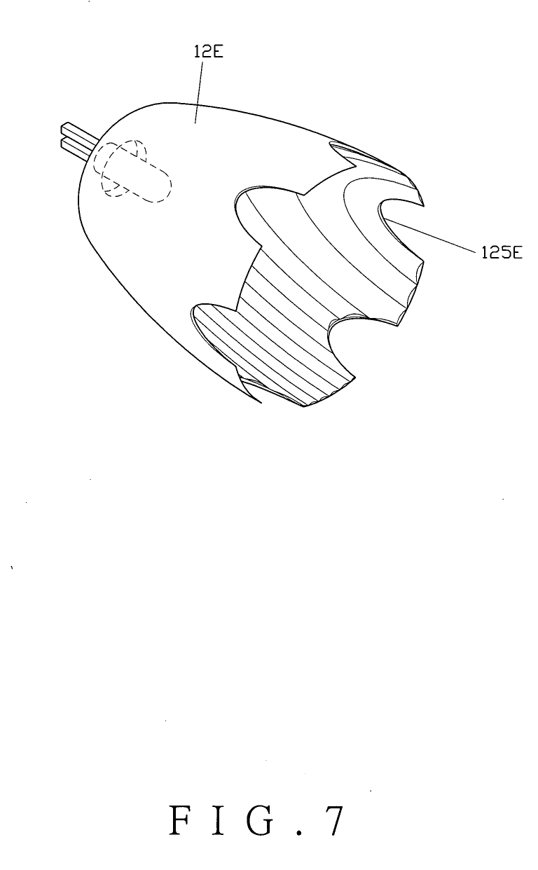

As shown in FIG. 7, a sixth embodiment of the present invention comprises a conical bulb socket 12E having a plurality of indentations 125E. The indentations 125E are formed in an arc shape and equally spaced from one another.

I claim:

1. A taillight socket structure comprising a taillight body, said taillight body comprising a plurality of conical bulb sockets therein, and characterized in that: each said conical bulb socket comprising an inner wall formed with multiple non-flat refractors and a plurality of indentation around its peripheral portion.

2. The taillight socket structure, as recited in claim 1, wherein said refractors of each said conical bulb socket are shaped in a strip protuberance.

3. The taillight socket structure, as recited in claim 1, wherein said refractors of each said conical bulb socket are circular refractors.

4. The taillight socket structure, as recited in claim 1, wherein said refractors of each said conical bulb socket are arranged in a crisscross pattern.

5. The taillight socket structure, as recited in claim 1, wherein said refractors of each said conical bulb socket are formed in an awl shape.

6. The taillight socket structure, as recited in claim 1, wherein said refractors of each said conical bulb socket are formed in a semi-spherical shape.

7. The taillight socket structure, as recited in claim 1, wherein said indentations of each said conical bulb socket are formed in an arc shape.

8. The taillight socket structure, as recited in claim 1, wherein said indentations of each said conical bulb socket are equally spaced from one another.

9. The taillight socket structure, as recited in claim 7, wherein said indentations of each said conical bulb socket are equally spaced from one another.

10. The taillight socket structure, as recited in claim 1, wherein said indentations of each said conical bulb socket are formed in a series of arrangement.

11. The taillight socket structure, as recited in claim 7, wherein said indentations of each said conical bulb socket are formed in a series of arrangement.
